(19) United States
(12) Patent Application Publication
(10) Pub. No.: US 2014/0379480 A1
(43) Pub. Date: Dec. 25, 2014

(54) SYSTEMS, METHODS, AND DEVICES FOR INTERACTIVE MARKETING WITH ATTRIBUTION USING PROXIMITY SENSORS

(71) Applicants: Vinay Rama Rao, Fremont, CA (US); Santanu Das, Monroe, CT (US)

(72) Inventors: Vinay Rama Rao, Fremont, CA (US); Santanu Das, Monroe, CT (US)

(73) Assignee: README SYSTEMS, INC., Milpitas, CA (US)

(21) Appl. No.: 14/481,857

(22) Filed: Sep. 9, 2014

Related U.S. Application Data
(63) Continuation-in-part of application No. 14/158,772, filed on Jan. 17, 2014.
Application No. 14/158,772 is a continuation-in-part of application No. 14/072,742, filed on Nov. 5, 2013.
(60) Provisional application No. 62/011,816, filed on Jun. 13, 2014.
(60) Provisional application No. 61/834,352, filed on Jun. 12, 2013.
(60) Provisional application No. 61/815,935, filed on Apr. 25, 2013.

(51) Int. Cl. G06Q 30/02; G06F 3/0484

(52) U.S. Cl. CPC G06Q 30/0261; G06Q 30/0267; G06F 3/0484
USPC 705/14.58

(57) ABSTRACT

Embodiments of the present disclosure is directed to systems, methods and devices for interactive marketing with attribution using proximity sensors. Embodiments include interactive marketing displays coupled to an interactive marketing display controller, that provide marketing information to a shopper and allow the shopper to interact with it such that the interactive marketing display controller records interaction data with the shopper and a timestamp of interaction. Further, embodiments include data sensors that are in proximity to an interactive marketing displays such that the data sensor senses a shopper's mobile device, acquires a device identifier of the mobile device, and records a timestamp of when the mobile device is sensed. Additional embodiments include an interactive marketing display provider's server to combine the interaction data and the device identifier of the mobile device and provides the combined interaction data and device identifier to the retail server for attribution.

### CROSS-REFERENCE TO RELATED APPLICATIONS

The present application claims the benefit under the US law and rules including 35 U.S.C. §119(e) from U.S. Provisional Patent Application Ser. No. 62/011,816 filed on Jun. 13, 2014 the entire contents of which is being incorporated herein by reference.

The present application is a continuation-in-part, under the US laws and rules, of U.S. patent application Ser. No. 14/158,772 filed on Jan. 17, 2014 the entire contents of which is being incorporated herein by reference.

U.S. patent application Ser. No. 14/158,772 filed on Jan. 17, 2014 is a continuation-in-part of U.S. patent application Ser. No. 14/072,742 filed on Nov. 5, 2013 the entire contents of which is being incorporated herein by reference.

Further, U.S. patent application Ser. No. 14/072,742 filed on Nov. 5, 2013 claims benefit under the US law and rules including 35 U.S.C. §119(e) from U.S. Provisional Patent Application Ser. No. 61/815,935 filed on Apr. 25, 2013 the entire contents of which is being incorporated herein by reference.

In addition, U.S. patent application Ser. No. 14/072,742 filed on Nov. 5, 2013 claims benefit under the US law and rules including 35 U.S.C. §119(e) from U.S. Provisional Patent Application Ser. No. 61/834,352 filed on Jun. 12, 2013 the entire contents of which is being incorporated herein by reference.

In addition, U.S. patent application Ser. No. 14/072,742 filed on Nov. 5, 2013 claims benefit under the US law and rules including 35 U.S.C. §119(e) from U.S. Provisional Patent Application Ser. No. 61/815,935 filed on Apr. 25, 2013 the entire contents of which is being incorporated herein by reference.

The present application is related to U.S. patent application Ser. No. 14/072,750 (Techlaw Docket No. 13-090-B) titled “Systems, Methods, and Devices for Providing a Retail Store Platform For Interacting with Shoppers in Real-Time” filed Nov. 5, 2013 and the entire contents of which is being incorporated by reference.

The present application is related to U.S. Patent Application No. ______ (Techlaw Docket No. 14-066-NP-US-B) titled “Systems, Methods, and Devices for Interactive Marketing with Attribution Using Proximity Sensors” filed herewith and the entire contents of which is being incorporated by reference.

### BACKGROUND

In the current market landscape, 70% of shoppers are making retail buying decisions in front of products in retailers' aisles. Such a decision process has been coined by leading Consumer Product Group (CPG) Company Proctor & Gamble (P&G) to be a “First Moment of Truth”, and is defined to be the brief time period from the time when a consumer encounters branded product to the time in which to influence the consumer's decision to purchase the branded product. CPG companies are on a quest to find new ways to market themselves to shoppers during the First Moment of Truth to influence their purchasing decisions in real time and to generate brand awareness using packaging of a product, display of a product, incentives, brand loyalty, new product introduction, product information, shopper surveys as well as other mechanisms.

Hence, for more effectiveness, there is a need for a retail store system platform for interacting with shoppers in real time for influencing purchasing decisions and to generate brand awareness when shoppers are in front of products in retailer aisles during the “First Moment of Truth.” Combining such a platform based on array of sensors with a set of interactive marketing displays placed strategically in shopping malls, stadiums, sporting venues, etc. allows attribution of particular transactions performed by a shopper in retail stores in the shopping mall or in the venues with previous interactions with such interactive marketing displays.

### SUMMARY

Embodiments of the present disclosure are based on the use of spatially diverse multiple antenna structures and associated radio transmitters and receivers in a sensor for accurate proximity detection. Further embodiments of the present disclosure are based on a platform comprising of an array of such sensors and include applications and schemes that are varied and diverse including health care, retail, manufacturing, traffic control, security etc. Additional embodiments include combining such a platform based on an array of sensors with a set of interactive marketing displays placed strategically in malls, stadiums, sports venues, etc. This combination allows attribution of particular transactions performed by a shopper in one or more retail stores with his/her interaction earlier with the interactive marketing displays in the shopping mall, stadiums, or venues. Attribution is a process of identifying a set of shopper actions (e.g. events) that contribute to a desired outcome (e.g. purchase of a product), and then assigning a value to each of these events. Marketing attribution provides an understanding of the combination of events that influence shoppers to engage in a desired behavior (i.e. conversion).

In a retail environment, a system based on a network of such (smart) sensors can accurately detect presence and location of a shopper's wireless mobile device, wearables, a wireless tag in a shopping cart, as the shopper moves along the shopping aisles carrying the wireless mobile device (e.g. smartphone). Based on the location of the shopper and the duration of the shopper stopping in front of a product shelf in an aisle, embodiments can engage the shopper (through the wireless mobile device, or other similar devices such as wearables) in transaction-oriented interactions using the ‘sense, analyze, and connect’ capability of the various embodiments described herein. Such interactions result in increased revenue for the retailers as well as better understanding of the shopping behavior of the retail shoppers. Such understanding can be embodied in improved analytics.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a functional block diagram of a system providing a retail store platform for interacting with shoppers in real time in accordance with some embodiments.

FIG. 1B is a functional block diagram of a system for interactive marketing with attribution using proximity sensors in accordance with some embodiments.

FIG. 1C is a functional block diagram of a system for interactive marketing with attribution using proximity sensors and gamification in accordance with some embodiments.

FIG. 1D is a functional block diagram of a system for interactive marketing with attribution using proximity sensors and wireless carrier generated information in accordance with some embodiments.

FIG. 2 is a functional block diagram of a data sensor used in a system for interactive marketing with attribution with proximity sensors in accordance with some embodiments.

FIG. 3 is a functional block diagram of a sensor provider's computer server used in a system for interactive marketing with attribution with proximity sensors in accordance with some embodiments.

FIG. 4 is a functional block diagram of an interactive marketing display provider's computer server used in a system for interactive marketing with attribution with proximity sensors in accordance with some embodiments.

FIG. 5 is a functional block diagram of a retailer computer server used in a system for interactive marketing with attribution with proximity sensors in accordance with some embodiments.

FIGS. 6-9 are example flowcharts of methods for interactive marketing with attribution with proximity sensors in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Systems, methods, and devices for interactive marketing with attribution using proximity sensors are disclosed. Embodiments include a system or platform being based on a combination of wireless-enabled sensors located strategically in retail stores, malls, stadiums, and event venues, etc. as well as one or more computer servers placed locally, remotely, or in a cloud. Wireless-enabled sensors are used to detect the presence of wireless mobile devices of shoppers and attendees. Sensors are placed at various points in the retail store, mall, stadium and event venues including in front of products in retail aisles and other points such as entry and exit points and checkout counters. The system captures the profile of the shoppers or attendees based on, among other things, a Media Access Control (MAC) identifier, Universally Unique Identifier (UUID), International Mobile Subscriber Identity (IMSI), International Mobile Equipment Identity (IMEI), or similar unique identifier of the mobile device. Note, shoppers and attendees may be called end users. Further, shoppers, attendees, and end users may be used interchangeably in the present disclosure. A proprietary unique device identifier, Readme Systems unique device identifier (RMSUDI), can also be created/generated based on any combination of MAC identifier, UUID, IMSI, IMEI, and other information based on customer input or customer usage behavior. Any combination of MAC identifier, a UUID, IMSI, IMEI or the proprietary unique device identifier can be a device identifier for a shopper's wireless mobile device. The computer servers receive and analyze the shoppers' profiles based on pre-stored and newly sensed (i.e. acquired by the wireless-enabled sensors) information. The analyzed profiles are used to connect with shoppers in real time to push coupons, incentives, product information, etc., to the shoppers' wireless mobile devices. The sensed information, in conjunction with the pre-stored data, is also used to generate or update the shoppers' profiles and generate analytics related to shopper behavior, brand loyalty, etc.

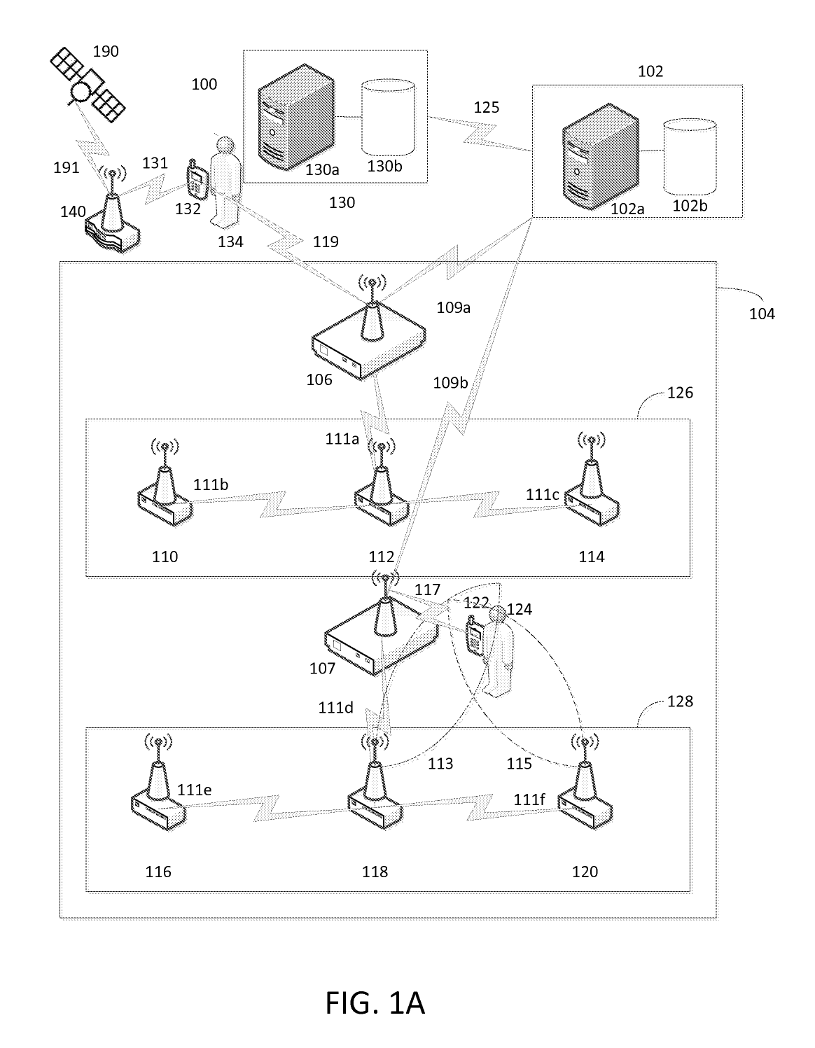

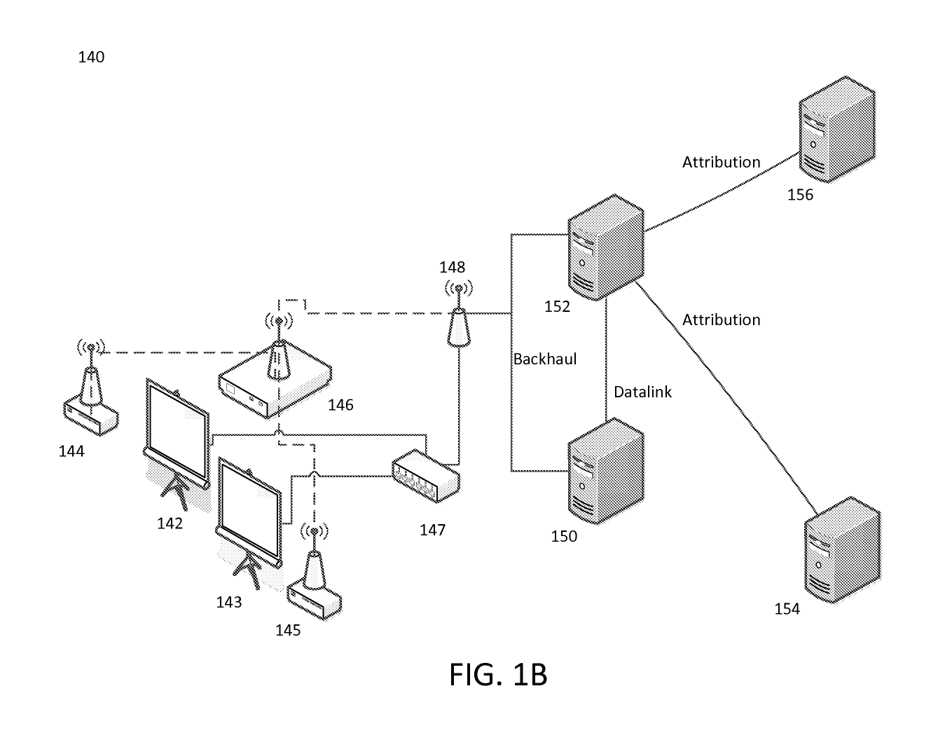

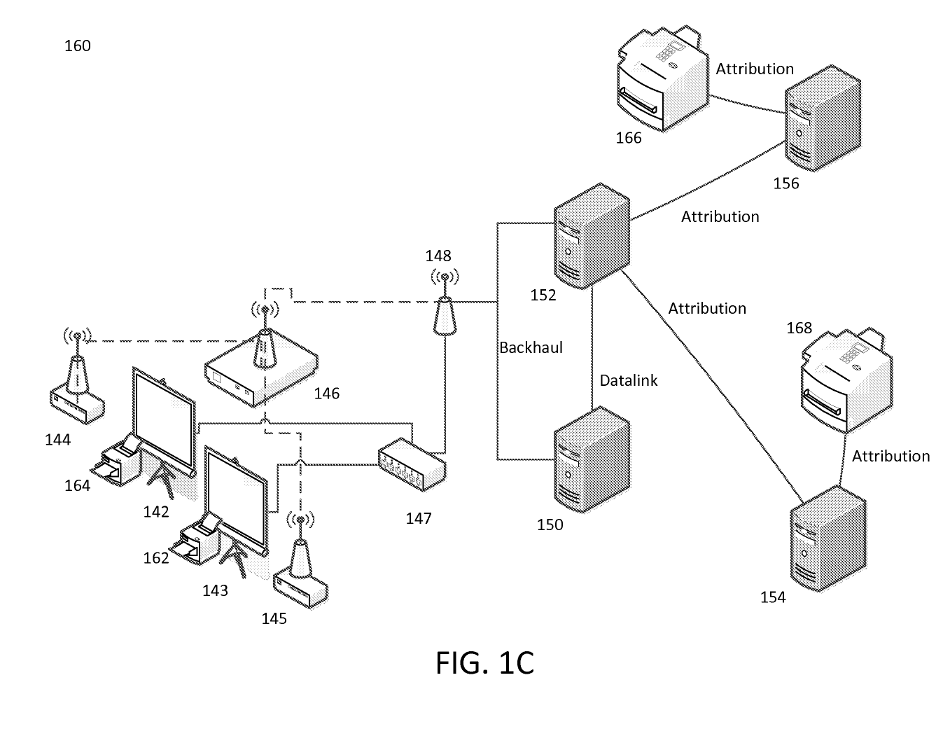

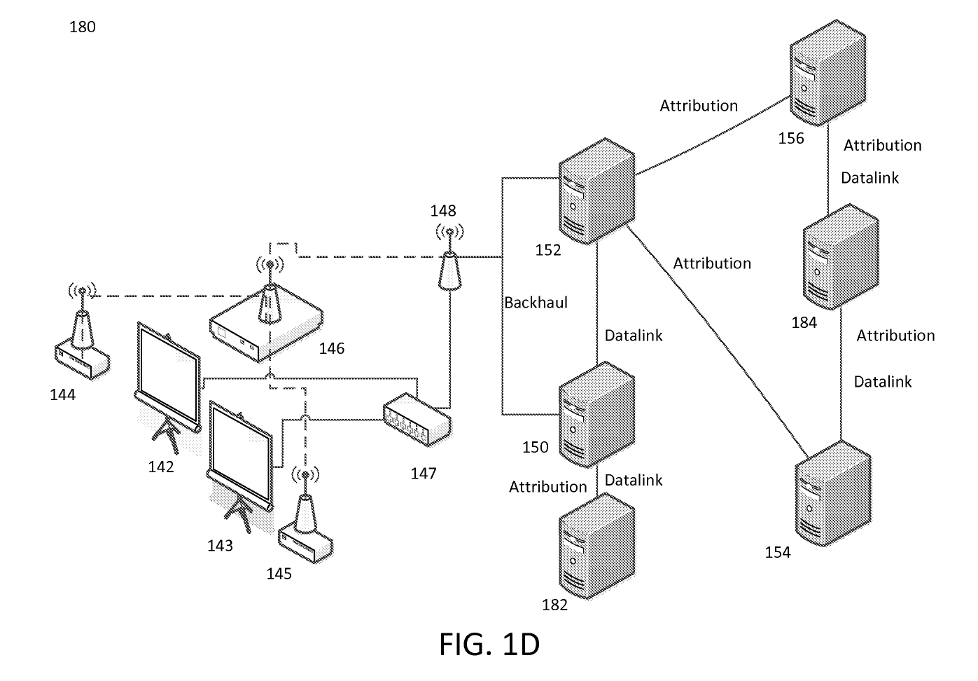

FIG. 1A is a functional block diagram of a system 100 providing a retail store platform for interacting with shoppers in real time in accordance with some embodiments. The system 100 includes gateway sensor nodes (106-107) and a set of data sensors (110-120) that comprise a sensor network located throughout a retail store 104. Some of the data sensors (110-114) may be located in one aisle 126 while some other data sensors (116-120) may be located in another aisle 128 of many such aisles in the retail store 104. The data sensors (110-120) are coupled to the set of gateway sensors nodes (106-107) over one or more communication networks (111a-111d). In one embodiment, the data sensor 112 is coupled to the gateway sensor node 106 and data sensors 110 and 114. Any communication between gateway sensor node 106 to either data sensor 110 and data sensor 114 is relayed by data sensor 112. Analogously, data sensor 118 is coupled to the gateway sensor node 107 and data sensors 116 and 120. Any communication from the gateway sensor node 107 to either data sensor 116 and data sensor 120 is relayed by data sensor 118. In other embodiments, each data sensor (110-120) may be coupled to gateway sensor nodes individually over a communication network or coupled to the gateway sensor nodes in a star or mesh communication network. In some embodiments such a communication network (111a-111d) may be a wireless network while in other embodiments the communication network may be a land-line network. In some embodiment, the data sensors (110-120) are coupled to the gateways sensors nodes using a WiFi network while in other embodiments the data sensors (110-120) are coupled to the gateways sensors using an Industrial, Scientific, Medical (ISM) protocol (operating at 902-928 MHz, and all ISM bands ranging from 433 MHz to 5.8 GHz, radio can be ultra wideband, chirp, and narrowband type) over a communication network.

Each data sensor (110-120) may be located in an aisle (126-128) of the retail store 104 near one or more retail products shelved in the aisle (126-128). Further, each data sensor (110-120) may be provisioned such that it is associated with the one or more retail product display in the aisle (126-128) as described in the present disclosure. In addition, each gateways sensor node (106-107) may be attached or placed in the walls or ceilings of the retail store 104 or any location that can be conducive to be coupled to a subset of the data sensors (110-120) and the primary computer server 102. In some embodiments, medium size retail store may have 80 sensors and one gateways sensor node.

Further, the gateway sensor nodes (106-107) may be coupled to one or more primary computer server system 102) over one or more communication networks (109a-109b). The primary computer server system may include one or more primary computer server 102a and a primary database 102b. In the present disclosure, a computer server may, but not always, refer to embodiments that include a computer server system having one or more computer servers and one or more databases coupled to each other. The one or more computer servers may be co-located with each other or distributed among different locations. Likewise, the one or more one or more databases may be co-located with each other or distributed among different locations. In further embodiments, some of the one or more computer servers may be co-located and coupled to the one or more databases while in additional embodiments some of the one or more computer servers may be coupled to the one or more databases each of which are placed in different location. In still further embodiments, a computer server system may refer to at least one of a computer server and a database.

Further, the communication networks (109a and 109b) coupling the one or more gateways sensor nodes to the primary computer server (system) 102 may be, but not limited to, a wireless network, landline network, local area network (LAN), wide area network (WAN), satellite network, WiFi, and Internet. Further, the primary computer server (system) 102 may be coupled to secondary computer server system 130 over another communication network or a direct link 125. As with other embodiments that include a computer server, a secondary computer server may refer, in some embodiments, to a secondary computer server system that include one or more secondary computer servers 130a coupled to one or more secondary databases 130b. The communication network 125 may be but not limited to, a wireless network, landline network, local area network (LAN), wide area network (WAN), satellite network, WiFi, and Internet.

Moreover, the system 100 includes at least one calibration sensor 140 coupled to a global position system (GPS) 190 over a communication network 191. Such a communication network may be a satellite communication network. In other embodiments, the calibration sensor 140 may be coupled over one or more communication networks to one or more cellular base stations coupled to a GPS system.

Persons of ordinary skill in the art would understand that such a network of sensors may be used in different environments other than a retail store, including, but not limited to, shopping malls, stadiums, and event venues.

### Providing Electronic Incentives Based on Shopper Behavior

As the shopper 124 enters the retail store 104, the one or more gateway sensor nodes (106-107) are configured to detect the wireless mobile device 122 dynamically over a wireless communication network 117 (e.g. WiFi). Further, the gateway sensor nodes (106-107) query and collect a media access control (MAC) identifier (i.e. address) from the wireless mobile device 122 and records a timestamp. The MAC identifier may be a unique 12 or 16 character (hexadecimal) identifier associated with the wireless mobile device. The timestamp may be a sequence of characters or encoded information identifying when a certain event occurred by giving a date and time of day for the event or by recording a time interval from a reference date. Upon receipt, the one or more gateways sensor nodes (106-107) transmit the timestamp and the MAC identifier of the wireless mobile device 122 to the primary computer server 102 over the communication network 109b for storing and processing.

Further, the one or more gateways sensor nodes (106-107) transmit, on request from shopper, a network connectivity offer notification as well as a request for shopper profile information and tag module download offer notification to the wireless mobile device 122. Network connectivity allows the shopper 124 access (through a wireless (e.g. WiFi) network 117) to the Internet using the wireless mobile device 122. Thus, upon acceptance of the network connectivity offer, the wireless mobile device 122 may be coupled to the gateways sensor nodes (106-107) over the wireless network 117 (e.g. WiFi). Further, the gateway sensor nodes (106-107) may request the shopper 124 for the shopper profile information to be sent to the primary computer server to determine whether the shopper is a new customer or a previous customer. The shopper profile information may be stored in the primary database 102a and accessed based on a store loyalty card number or other information provided by the shopper 124 through the wireless mobile device 122 or using the possible combination of MAC ID, timestamps, proximity data, power level in dBm, SNR data (e.g. Signal to Noise Ratio between Client and Wireless Sensor), location data etc., collected by the sensor network.

In addition, the one or more gateways sensor nodes (106-107) offer the shopper 124, while accepting the network connectivity, to download a tag module allowing the shopper 124 to receive purchase incentives. The tag module may include a wireless application to be downloaded to the wireless mobile device 122. Moreover, the one or more gateways sensor nodes (106-107) may receive (affirmative) instructions in response to the tag module download offer from the wireless mobile device 122 to couple the wireless mobile device 122 to the wireless communication network 117 and to download a tag module. Upon receiving the instructions, the one or more gateways sensors nodes (106-107), in cooperation with the primary computer server 102, transmit a link to an application repository (e.g. Apple App Store, Android App Store, Windows App Store, Third party repositories, etc.) for downloading the tag module to the wireless mobile device 122 such that the wireless mobile device 122 can now be discerned as a “tagged” wireless mobile device because the wireless mobile device can now implement the tag module.

In a further embodiment, the data sensors (110-120) may be coupled to the one or more gateways sensor nodes (106-107) over a wireless communication network (111a-111f). Further, each data sensor (110-120) has at least one processor, at least one memory or electronic storage device, and a MAC identifier stored in such a memory device. In addition, each data sensor (110-120) may generate one or more personal communication networks (e.g. personal area networks (PANs) for Bluetooth connections), (113 and 115) using a directional antenna. Moreover, each data sensor (110-120) is configured to detect the tagged wireless mobile device 122 over one or more personal communication networks (113 and 115), which is based on Bluetooth Low Energy (BLE) or other wireless technology, and to request and receive the MAC identifier from the tagged wireless mobile device. Further, each of the data sensors (110-120) is configured to transmit the MAC identifier of the tagged wireless mobile device, the MAC identifier of data sensor to the primary computer server 102 through the one or more gateways sensor nodes (106-107) and one or more communication networks (111a-111f, 109a-109b). In such embodiments, the data sensors (110-120) can collect the MAC ID (or UUID) of a shopper's mobile phone (e.g. smartphone or legacy phone) using a personal communication network and this device identifier (device ID) information can be combined with other information (e.g. shopper information, shopper loyalty information, etc.) to generate a Unique User Binding; that is, the device identifier (MAC ID or UUID) is at least associated with a shopper's identity information.

The system 100 includes a data sensor 120 coupled to the gateway sensor node 107 over communication network (111a-111f). Such a data sensor 120 may be in a location or position to provide electronic product information and/or electronic product purchase incentive because of its location or association with a particular product for which there may be a promotion. Such a data sensor 120, herein called an incentive data sensor, has a MAC identifier stored in a memory device and a processor and generates a corresponding personal communication network 115 (like any other of the data sensors (110-120)). Further, the incentive data sensor is configured to detect the tagged wireless mobile device 122 over the personal communication network 115 and determine that the tagged wireless mobile device is in communication with the data sensor exceeding a predetermined threshold of time period. That is, a shopper 124 may be browsing products throughout the aisles (126-128) of the retail store 104 for possible purchases. The owner and operator of system 100 may have knowledge that a shopper who stops in front of a product between 5-7 seconds is contemplating a purchase (i.e. “First Moment of Truth”). Thus, the predetermined threshold of time period may be configured to be 5 seconds. When the predetermined threshold of time has been exceeded, then the incentive data sensor 120 may request and receive the MAC identifier from the tagged wireless mobile device 122 and transmit the MAC identifier of the tagged wireless mobile device, the MAC identifier of the incentive data sensor 120 to the one or more computer servers through the one or more gateway sensor nodes over a communication network. Note that an incentive data sensor may be any data sensor in the system 100. Further, in some embodiments, no electronic product purchase incentive is transmitted to a tagged wireless mobile device even though the predetermined threshold of time has been exceeded.

The primary computer server 102 processes the information received from the incentive data sensor 120 including the MAC identifier of the tagged wireless mobile device 122 and the MAC identifier of the incentive data sensor 120. The primary computer server 102 include a primary databases 102b and looks up shopper 124 information based on the MAC identifier of the tagged wireless mobile device 122. Moreover, the primary computer server 102 may look up the product on the aisle 128 associated with the MAC identifier of the incentive data sensor 120. Upon processing the information received from the incentive data sensor 120 (including looking up the product associated with the incentive data sensor 120), the primary computer server 102 may provide instructions, product information, and an electronic product purchase incentive to the incentive data sensor 120. The electronic product purchase incentive may be an electronic coupon, rebate, discount, promotion, or any other incentive redeemable at a point-of-sale (POS) terminal that may persuade the shopper 124 to purchase the product associated with the incentive data sensor 120.

Further, the incentive data sensor 120 may receive at least one of one or more instructions, product information and electronic product purchase incentive from the primary computer server 102 and transmits a notification requesting interaction with the tagged wireless mobile device 122 that includes a notification of an offer of the electronic product purchase incentive ready to be sent to the tagged wireless mobile device 122. When the tagged wireless mobile device 122 receives the notification, the shopper 124 may input an affirmation to have the tagged wireless mobile device interact with the primary computer server 102 through either a gateway sensor 107 or incentive data sensor 120. Moreover, the incentive data sensor 120 receives one or more instructions from the tagged wireless mobile device to transmit the electronic product purchase incentive to the tagged wireless mobile device 122. In some embodiment, the electronic product purchase incentive can be sent by the primary server to the ‘tagged’ mobile device using text messaging, Short Messaging Service (SMS), and /or Multimedia Messaging Service (MMS), in cooperation with a carrier of the mobile phone or some other third-party service provider. (In the present disclosure, the terms carrier and third party provider may be used interchangeably). In further embodiments, a HyperText Transfer Protocol (HTTP) (or any other communication, e.g. email) session between the server of the service provider, who owns the retail store, and the tagged wireless mobile device can be also used to download product incentive information and also to support interaction between the shopper and the server in real-time when the shopper is in the store. Such a communication scenario may be considered a communication session.

In one embodiment, each of the first set of data sensors and the incentive data sensor includes one or more batteries to provide power to a corresponding data sensor and that the corresponding data sensor receives one or more power duty cycling commands to conserve power from the one or more gateways sensor nodes. The power duty cycling commands include a sleep command and a wake command such that the corresponding data sensor has a power duty cycle of a power duty time period, a sleep time period that is a portion of the power duty time period, and an awake time period that is a portion of the power duty time period.

Note that a data sensor may also be called a department sensor and that a data sensor and a department sensor may be used interchangeably in the present disclosure.

### Interactive Marketing with Attribution Using Proximity Sensors

In another set of embodiments, systems, methods, and devices may perform interactive marketing with attribution using proximity sensors. Such embodiments may include interactive marketing displays which are devices that not only display marketing materials for a brand, company or product but also allow an end user (e.g. shopper) to interact via a touch screen, voice recognition or other input mechanism. For example, an interactive marketing display may include a touchscreen that displays a dress for a woman at a retail store. The same interactive marketing display may also allow an end user (shopper) to interact with the display via a touchscreen input mechanism to display the dress in a user selected style, size, color, etc. The interactive marketing display system may record the selections and input provided by the end user (shopper) to generate analytics information. By interactive marketing display system, the present disclosure means the combination of the displays, the local display controller and interactive marketing display provider's server.

While a stand alone interactive marketing display allows an end user to engage with the retailer, having one or more data sensors in proximity of the interactive marketing display allows sensing of the shopper's mobile device identifier when the shopper is interacting with the retailer through the interactive marketing display. This information, combined with the fact that the shopper used the interactive marketing display in a certain manner allows the combined interactive marketing display and the sensor based platform to generate improved analytics information. Further, if the interactive marketing display is located in the common area of a shopping mall, when a particular shopper purchases the items which the end user selected for display on the interactive marketing display, the retail stores located in the shopping mall can attribute the particular transaction to the fact the shopper recorded his/her interest in the item earlier through the interaction with the display in the shopping mall. This may require that the server controlling the interactive marketing displays is able to input the interaction event with the particular shopper, including the shopper's identity using the device identifier of the shopper's mobile phone to the server of the retail store which controls the POS terminals of the retailer.

The data sensors placed near the interactive marketing displays may be equipped with WiFi, Bluetooth (BT) and/or Bluetooth Low Energy (BLE) technologies to detect the shopper's (wireless) mobile phone. The detection (or sensing) of the shopper's mobile phone includes determining the MAC ID or device identifier of the mobile phone. As mentioned in the present disclosure, the data sensors may forward, through a gateway sensor (node), the device identifier to a cloud server controlling the data sensors. Similarly, the interactive marketing display may also forward information, pertaining to a shopper's interaction with the display, to the interactive marketing display controller which then forwards the information to a cloud server that further controls the interactive display. If the cloud server controlling the interactive displays, exchanges information with retailer's server, the actual purchase of the items by a shopper can be attributed to the fact that the particular shopper earlier interacted with an interactive marketing display to record his/her interest in the particular item. It is assumed that the cloud server of the sensor provider exchanges information with the cloud server of the interactive marketing display provider to facilitate the attribution.

FIG. 1B is a functional block diagram of a system 140 for interactive marketing with attribution using proximity sensors in accordance with some embodiments. The system 140 includes data sensors (144-145) in proximity with interactive marketing displays (142-143), the data sensors (144-145) being wirelessly coupled to a gateways sensor (node) 146. Further, the gateway sensor 146 is coupled (wireless or wired) to an access point 148 and the interactive marketing displays (142-143) are coupled (wirelessly or wired) to access point 148 via an interactive marketing display controller 147. The interactive marketing display controller 147 may be used to provide configuration information to or receive interaction data from the interactive marketing displays (142-143). In addition, the access point 148 is coupled via a backhaul network to servers 150 and 152. The access point can be WiFi based or LTE based or a combination thereof. Server 152 may be located in a network operation center controlled and operated by the interactive marketing display service provider or in the cloud. Server 150 may be stand alone server or a cloud server controlled and operated by the sensor provider. Moreover, the servers 150 and 152 may be coupled together with a datalink connection to communicate with each other to facilitate attribution. Further, server 152 may be coupled to and communicate with servers 154 and 156. Server 154 and 156 each may be controlled and operated by different retailers. In addition, the server 152 may be of an interactive marketing display provider and may process data and information from both the interactive marketing display 142 and the data sensors (144-145) to attribute certain analytics information to certain shoppers. Such attribution information is provided by the interactive marketing display provider's server 152 to one or more retailer servers 154 and 156. In certain embodiments, the servers 150 and 152 may be the one in the same. In other embodiments, servers 150 and 152 may be different servers such that server 150, instead of server 152, may be coupled to and communicate with servers 154 and 156.

For example, when a shopper, having a mobile phone (e.g. smartphone), interacts with the interactive marketing displays (142-143), the data sensors (144-145) may sense or detect the presence of shopper's mobile phone and determine the mobile phone's device identifier. In some embodiments, the shopper may have downloaded a mobile software application (“app”) onto its mobile phone. This mobile application can be “common mobile application” that shopper can use with other retailers as well as the interactive marketing displays of the mall owner. In addition, this common mobile application function may be embedded inside popular mobile applications such as Google Maps through a business arrangement between the mall owners and the common mobile application (i.e. Google Maps). Such a mobile software application may determine the device identifier of the shopper's mobile phone. Further, the data sensor (144-145) may be able to communicate with the mobile software application on the shopper's mobile phone to access the device identifier of the shopper's mobile phone. In alternate embodiments, the shopper may not have downloaded a mobile software application. However, the data sensors (144-145) may communicate with the shopper's mobile phone and determine the device identifier (MAC ID) of the shopper's mobile phone using WiFi or Bluetooth technology. The data sensors (144-145) have ability to communicate with the shopper's mobile phone using WiFi, Bluetooth, or Bluetooth Low Energy technologies depending upon whether a mobile software application has been downloaded or not. In either set of embodiments, the device identifier as well as a timestamp of when the shopper's mobile phone was detected or device identifier was acquired is transmitted via the gateway sensor 146 and access point 148 from the data sensors (144-145) to server 150 operated by the sensor provider.

Further, when the shopper interacts with the interactive marketing display 142, the interactive marketing display 142 may show a dress sold by a retailer. The interactive marketing display 142 may allow the shopper to select a different style, color, size. etc. of the dress and display the dress based on user selections. When the shopper makes such selections, the interactive marketing display 142 and the interactive marketing display controller 147 record such interactions and transmits such interaction data to the server 152 via the access point and interactive marketing display controller 147. Such interaction data would include timestamps of the shopper's different interactions with the interactive marketing display 142. The interactive marketing display provider's server 152 receives the device identifier and timestamp of when the shopper's mobile phone was sensed/detected by the data sensors (144-145) by the sensor provider's server 150. Further, the interactive marketing display provider server 152 processes the interaction data as well as the device identifier and timestamp provided by the sensor provider server 150 to attribute the interaction data with the shopper by associating the interaction data with the device identifier of the shopper's mobile phone based on the timestamp associated with interaction data and the timestamp of when the shopper's mobile phone was detected (or device identifier was acquired). Such attribution information may then be transmitted to one or more retailer servers (154-156). In other embodiments, interaction data only may be transmitted to one or more retailer servers (154-156). A retailer may use the attribution information (e.g. shopper's mobile device identifier) along with a CRM database to match the actual shopper identity (e.g. any combination of name, telephone number, email address, loyalty card information) with the attribution information obtained from the interactive marketing display provider server 152.

There may be a proximity (data) sensor next to the POS terminal of the retailer, such sensor detecting the device identifier of the shopper's mobile device. This device identifier information can be matched by the retailer server against earlier received information about interaction between the shopper and the interactive marketing display controller, thus, completing the loop for attribution.

### Interactive Marketing with Attribution Using Proximity Sensors and Gamification

FIG. 1C is a functional block diagram of a system for attribution of interactive marketing using proximity sensors and gamification in accordance with some embodiments. FIG. 1C is similar to FIG. 1B with the addition of printers (162-164) associated with the interactive marketing displays (142-143) and a point of sale (POS) terminal 166 coupled to a retailer server 156 and another point of sale terminal coupled to retailer server 154. The use of interactive marketing displays combined with a platform of proximity sensors allows the shoppers not only to participate in interacting with the interactive marketing displays but also in gamification. Gamification is the use of game thinking and game mechanics in non-game contexts to engage users in solving problems. In embodiments of the present disclosure, gamification techniques may be used to engage shoppers in using interactive marketing displays and deepen overall engagement with the shopper. The gamification can take many forms including simple questions and answers to complex online auction processes. For example, if a shopper develops affinity for a particular product through his/her interaction with the interactive marketing displays, the system can offer the shopper a number of possibilities for transactions including: (a) reserving a product for a limited duration of time. if he/she provides a telephone number or email address or loyalty card information; (b) participating in a layaway program by providing email address, telephone number or loyalty card information; and (c) the possibility of offering a bid for the product in an online auction process which could be lower than the listed price, if he/she provides telephone number, email address, or loyalty card information. If the system (including the interactive marketing display controller 147) perceives that the shopper has engaged deeply (over a predetermined threshold, e.g. three levels, three selections, etc.) with an interactive marketing display but is not willing to participate in one or more or transaction types displayed previously on the interactive marketing display, the system (including the interactive marketing display controller 147) can offer a coupon (or other purchase incentive) for the product if the shopper will provide email address, telephone number or loyalty card information or some other form of personal information (which could be similar to login credentials as is used in connection with an email address account). Gamification in this context can be a lot more sophisticated using more complex techniques.

A printer, similar to one found in an Automatic Teller Machine (ATM), located near the interactive marketing display can print the coupon which can be redeemed for a limited time at a store in a mall, for example. The printer is coupled to the interactive marketing display controller 147 directly (wired or wirelessly) or indirectly (wired or wirelessly) through the interactive marketing displays (142-143). The interactive marketing display controller may provide and/or instruct the printer (directly or indirectly through the interactive marketing displays (142-143)) to print the coupon (or other purchase incentive) for the shopper. The redemption of the coupon may trigger an attribution process, attributing that transaction to the fact that the shopper previously had interacted with a specific interactive marketing display in certain manner. The reservation process, layaway process, and online auction process allow for attribution of an interaction with the display with particular transaction and possibly with the particular shopper based on the shopper's email address, telephone, and loyalty card information. Instead of using a printer to access a coupon, the shopper can take a picture (i.e. image capture) of the product/product number or use Bluetooth capability of the mobile phone to take an impression of the product. This picture or impression can be used during actual product purchase for identification of the product, facilitating attribution. Note, in the present disclosure, a purchase incentive for a product may include, but is not limited to, a coupon, discount, reservation, layaway, and a bid for an online auction.

### Interactive Marketing with Attribution Using Proximity Sensors and Wireless Carrier Generated Information

FIG. 1D is a functional block diagram of a system for attribution with interactive marketing displays using proximity sensors and wireless carrier generated information in accordance with some embodiments. FIG. 1D is similar to FIG. 1B with the addition of a wireless carrier server 182 coupled to the sensor provider's server 150 and a customer relationship management (CRM) server (e.g. MyBuys) 184 coupled to a retailer server 156. An additional method of attribution of an interaction session by a shopper with an interactive marketing display may include a transaction which may take place subsequently for that particular product or merchandise in a retail store. Further the retail store may use information provided by a wireless carrier about the particular shopper as he/she is interacting with the interactive marketing display. The retrieval of the shopper's identity would require the sensor provider's server 150 interacting with the wireless carrier server 182 when the system perceives that the engagement is sufficiently deep. For example, the interactive marketing display 142 may allow the shopper to make multiple selections of styling an advertised dress, (e.g. color, size, length, etc.) such that a threshold to determine whether a shopper is sufficiently deep in interacting with the interactive marketing display may be shopper making three selections.

The sensor provider's server 150, at that point (instructed by the interactive marketing display provider's server, for example), may provide the location information of the sensor (latitude and longitude) to one or more wireless carriers (specifically their servers) who have a professional alliance with the provider of the sensors, and in response, each wireless carrier provides a telephone number or one or more device identifiers of the subscribers of the carriers who are associated with that particular location. Because of the coarse granularity of association of subscribers with location information possible with current carrier technologies, multiple possible subscriber identification may be associated with the coordinates of the sensor associated with the interactive marketing display. While there is an ambiguity in attribution, this ambiguity can be resolved to a certain extent when the shopper appears for a transaction at the retailer's POS terminal if the retailer has access to CRM or other databases (e.g. MyBuys). Such a CRM database may store shopper personal information associated with the device identifier of the shopper's mobile device thereby facilitating attribution of a shopper's transaction with an earlier interaction with an interactive marketing display. With widespread deployment of LTE technology and improvement of localization algorithms, the wireless carrier assisted localization will improve in accuracy. Some recently published academic papers have proven that accuracy better than 1 meter is possible with wireless carrier assisted localization, thus reducing the ambiguity of attribution.

The ambiguity may also be resolved by the fact that a proximity sensor next to the POS terminal may be able to determine the device identifier of the shopper's mobile device and match it against the device identifiers obtained through the carrier's localization mechanism.

In another embodiment of wireless carrier generated information, the LTE base stations or LTE cells could be located in strategic locations in the mall having multiple LTE base stations close to the interactive marketing displays will allow the wireless carrier to generate more precise location information when wireless carrier assistance sought by the sensor provider.

### Interactive Marketing with Attribution Using Wifi Beacon Stuffing

Beacon stuffing, a low bandwidth communication protocol for IEEE 802.11 networks, enables WiFi access points (APs) to communicate with clients without association. This enables clients (PC, tablets, smartphones, or other devices) to receive information from nearby APs even when they are disconnected, or when connected to another AP. This allows information exchange from an AP to an unconnected client by using the 802.11 management frames. This beacon stuffing protocol is based on two technical aspects. First, clients receive beacons from APs even when they are not associated with them. Second, it is possible to overload fields in the beacon and other management frames to embed some desired data. APs embed content in beacon and probe response frames while clients overload probe requests to send data.

Beacons stuffing enables a number of new applications. For instance, APs can embed network selection content into beacons with the beacon stuffing protocol. For example, this can be used to broadcast performance or pricing information about the wireless network. Another example application of beacon stuffing is for APs to send location-specific advertisements to nearby clients that are not associated to it. This can be used to advertise real world goods and services (in e.g. coffee shop and restaurant). Finally as an extension of location-specific advertisements, APs may be configured to provide coupons or other incentives to nearby clients without requiring association.

Under common environmental conditions, the beacon frames have a range of 100-200 meters. By varying transmit power and using different encoding schemes, the range can be further controlled to make it shorter. The information to be broadcast using beacon stuffing is treated as a string of bytes. In most cases, the information is expected to be a short text message. However, the beacon stuffing can also be used to deliver non-text information such as a short audio jungle by splitting the message into smaller fragments and transmitting each fragment in a separate beacon.

Three specific techniques can be used to carry a message in a beacon: (1) SSID concatenation; (2) BSSID Concatenation; (3) Beacon Information Element. None of the three techniques require any modification to the hardware or firmware to receive the messages. For the SSID and BSSID based techniques a simple user level application is sufficient to reassemble the fragmented messages. The third technique, which uses Information Element, requires changes to the WiFi driver on the client device. The WiFi beacon stuffing can be used for attribution as follows. Assuming that the sensor has WiFi microsensing capability, when the interactive display controller determines that the shopper's interaction with the displays is deep enough (e.g. crossing an engagement threshold), it signals that condition to the associated sensor which immediately sends pricing information, product information, coupon, or any other relevant particular information about the product through beacon stuffing because the shopper is very close to the WiFi based sensor. He or she will receive the information even if he or she is not associated with that particular sensor which is acting as an access point. Such an embodiment assumes that the shopper has a mobile application loaded, the mobile application being associated with the shopping mall or particular venue. The coupon or any other incentive given to the shopper can be of limited time duration and the shopper can redeem the coupon or the discount voucher when he or she appears at the relevant POS terminal of the retailer, triggering association of an earlier interaction within interactive marketing display with actual product purchase, thus closing the loop of attribution. The advantage of this scheme is that only one mobile application associated with the shopping mall or venue needs to be loaded; there is no need for loading different mobile applications for different retailers. Such a mobile application can be referred to as a “common mobile application” as opposed to any mobile application which is a retailer or particular organization or entity specific. Any application which is retailer or organization or entity specific is referred to in the present disclosure as mobile applications (mobile apps). This scheme allows the owners of malls or venues to collaborate with the retailers and put access points within the areas controlled by the retailers to send product information, discount information, coupons, or any other purchase incentives. Each AP sends out information relevant to only the particular retailer on whose premises the AP is located and such information can be received by any mobile device by a shopper that is loaded with a common mobile application.

Another embodiment of using beacon stuffing techniques is based on the sensor provider having a business alliance with a provider of popular and frequently used location applications like Google Maps or similar applications whereby the specially designed applications associated with the beacon stuffing techniques can be made part of those popular applications. Thus, the scope of these popular applications may be expanded, through the business alliance, to include the capability of the beacon stuffing applications. If a shopper opens one of those popular applications when he or she is close to the mall owner's access point, then purchase incentives can be provided to the shopper when he or she interacts with an interactive marketing display. Of course, the purchase incentives can be provided even without interaction with the interactive marketing display; however, in such a case the linkage or attribution between a particular advertisement on the display and an actual transaction on retailer premises cannot be secured. A popular application when enhanced with the sensor provider's server beacon stuffing application will be referred in the present disclosure as a “modified application”.

The communication networks described with respect to FIGS. 1A-1D (and in the present disclosure generally) may be, but not limited to, a wireless network (cellular, Bluetooth, WiFi), landline network, local area network (LAN), wide area network (WAN), satellite network, ISM (Industrial, Scientific, and Medical—Frequencies allocated in 433 MHz-5.8 GHz for FCC 47 CFR Part 15.5) and Internet.

### Description of Sensors and Servers of the System for Interactive Marketing with Attribution Using Proximity Sensors

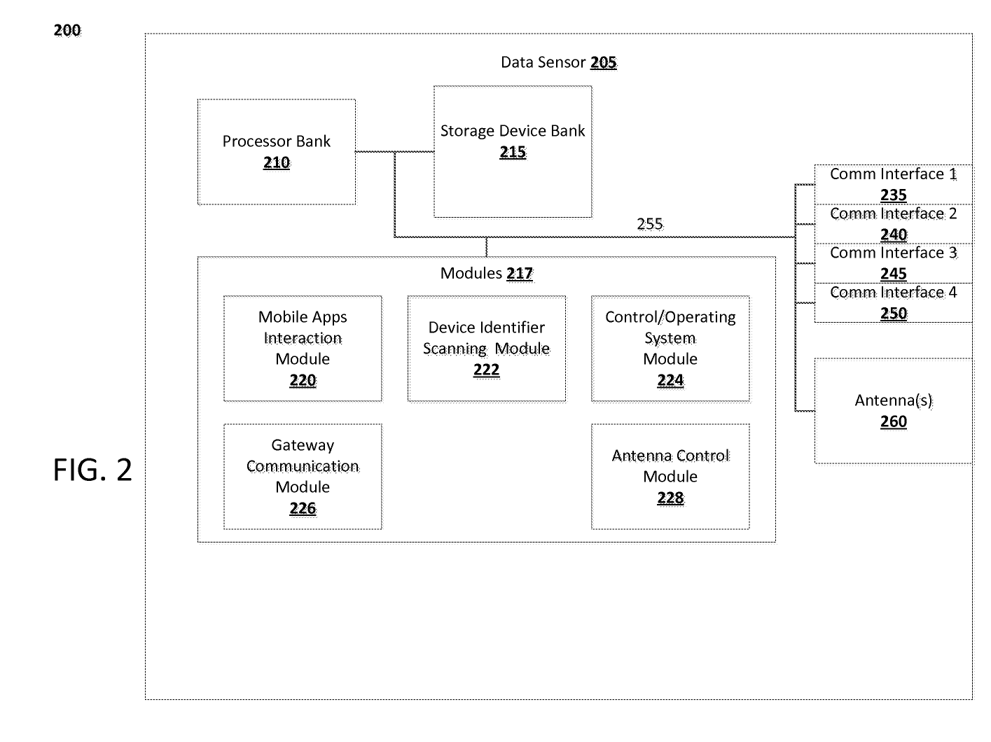

FIG. 2 is a functional block diagram of a data sensor 205 used in a system for interactive marketing with attribution with proximity sensors in accordance with some embodiments. Such a data sensor 205 may be used in a system shown in FIGS. 1B-1D. The data sensor 205 may include several different components such as a processor bank 210, storage device bank 215, one or more software applications, which may be executed by a processor. Thus, the combination of the software applications as well as the processor and any other hardware form specifically-configured module devices 217. The data sensor 205 also has one or more communication interfaces (235-250). Further, the data sensor 205 may include one or more antennas 260 The processor bank 210 may include one or more processors that may be co-located with each other or may be located in one module or in different parts of the data sensor 205. The storage device bank 215 may include one or more storage devices. Types of storage devices may include electronic memory, optical memory, and removable storage media. The one or more modules 217 may include a mobile applications (“apps”) interaction module 220, device identifier scanning module 222, control module/operating system (OS) 224, gateway communication module 226, and antenna control module 228. The modules 217 may be implemented by the one or more processors in the processor bank 210.

The mobile apps interaction module 220 may be used by the data sensor 205 in the embodiment when a shopper's mobile device in proximity to the data sensor 205 has downloaded a mobile application that is capable of communicating with the data sensor 205. Such a mobile application can access the device identifier of the shopper's mobile device. The mobile apps interaction module 220 on the data sensor 205 may query or request from the mobile application on the shopper's mobile device for the device identifier of the shopper's mobile device. In response to the query or request, the mobile application provides the device identifier to the mobile apps interaction module 220 of the data sensor 205.

The device identifier scanning module 222 receives the device identifier (e.g. MAC ID, UUID, or other identifier) from a shopper's mobile device. In one embodiment, the device identifier scanning module 222 may receive the device identifier from the mobile apps interaction module which has acquired the device identifier as described herein. However, in other embodiments, no mobile application may be downloaded on the shopper's mobile device. In such embodiments, the device identifier scanning module may scan and query the shopper's mobile device and acquire the device identifier of the mobile device using WiFi and/or Bluetooth technologies. Upon the acquiring the device identifier of the shopper's mobile device, the device identifier scanning module 222 also records a timestamp of the acquisition of the device identifier.

The control/OS module 224 may include control software applications that implement software functions that assist in performing certain tasks for the data sensor 205 such as providing access to a communication link (e.g. wired, wireless, Bluetooth, infra-red, RF, etc.), executing an operating system, managing software drivers for peripheral components, and processing information. In addition, the control/OS module 224 may also include software drivers for peripheral components, user interface computer programs, debugging and troubleshooting software tools. Also, the control/OS module 224 may include an operating system supported by the sensor provider computer server. Such operating systems are known in the art for such servers but may also include computer operating systems (e.g. Windows, Linux, UNIX, previous version of Windows and MacOS, etc.).

The gateway communication module 226 allows the data sensor 205 to communicate with a gateway sensor as described in the present disclosure. The communication can be wired or wireless and through WiFi, or any communication technology known in the art. Any data transmitted to a sensor provider's server is sent through the gateway sensor (and an access point). Note that there may be embodiments that allow the data sensor 205 to communicate with a sensor provider's server directly (wired or wirelessly) or through devices other than the gateway sensor.

The gateway communication module 226 may receive the device identifier of the shopper's mobile device and the timestamp when the data sensor 205 acquired the device identifier and transmit the device identifier and timestamp to the sensor provider's server via the gateway sensor (and through the access point).

The antenna control module 228 may be used in any embodiment of the sensor (e.g. gateway, data sensor, etc.). The data sensor 205 may include one or more antennas 260 that may include directional antennas as well as omnidirectional antennas. Further, the antenna control module 228 may control the polarization and radiation pattern produced by the directional antennas 260 and control receiver sensitivity/directivity as well as transmit power level of the directional antennas 260 to couple to other devices in a wireless network. Based on proximity and geographic location of the data sensor 205, the antenna control module 228 may adjust the radiation pattern of the directional antennas 260 to improve coupling of the sensor to other devices detected on the network. Further, the one or more antennas 260 may include a patch antenna, an array of patch antennas as well, antenna(s) constructed with high dielectric materials. In addition, the one or more antennas 260 can be used in conjunction with other modules implemented by the processor bank 210 to determine an approximate distance of a shopper's mobile device based on a measured received power level from such devices (using techniques known in the art, for example).

Each of the communication interfaces (235-250) may be software or hardware associated in communicating to other devices. The communication interfaces (235-250) may be of different types that include a user interface, USB, Ethernet, WiFi, WiMax, wireless, optical, cellular, or any other communication interface coupled to a communication network. One or more of the communication interfaces (235-250) may be coupled to a user interface known in the art, inter alia, for installation and diagnostic purposes.

In some embodiments, data sensor 205 generates one or more personal communication networks through the communication interfaces (235-250) using a corresponding directional antenna 260 to communicate with a shopper's mobile device. Such personal communication networks may be BLE, Bluetooth, and WiFi. Further, in such embodiments, the data sensor 205 may couple to an ISM wireless network through the communication interfaces (235-250) using an omnidirectional antenna 260 to communicate with one or more gateway sensor nodes.

An intra-device communication link 255 between the processor bank 210, storage device bank 215, modules 217, antennas 260 and communication interfaces (235-350) may be one of several types that include a bus or other communication mechanism.

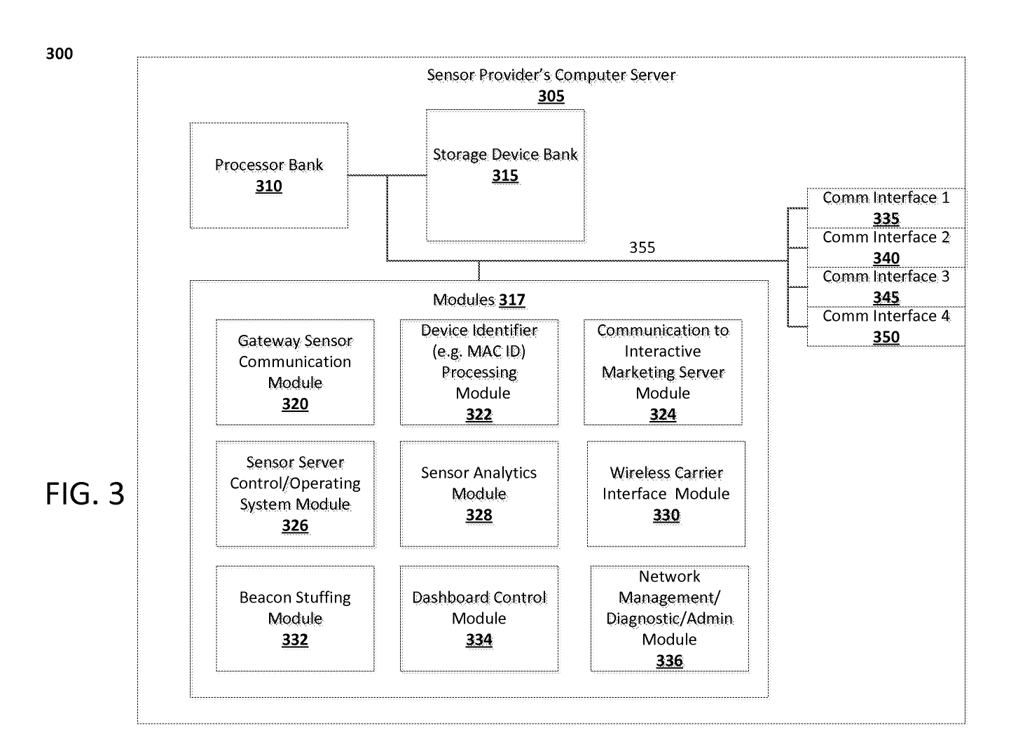

FIG. 3 is a functional block diagram of a sensor provider's computer server 305 used in a system for interactive marketing with attribution with proximity sensors in accordance with some embodiments. Such a sensor provider's (computer) server 305 may be used in a system shown in FIGS. 1B-1D and be operated by a sensor provider to control one or more gateway sensors and data sensors. The sensor provider's server 305 may include several different components such as a processor bank 310, storage device bank 315, one or more software applications, which may be executed by a processor. Thus, the combination of the software applications as well as the processor and any other hardware form specifically-configured module devices 317. The sensor provider server 305 also has one or more communication interfaces (335-350). The processor bank 310 may include one or more processors that may be co-located with each other or may be located in different parts of the sensor provider computer server 305. The storage device bank 315 may include one or more storage devices. Types of storage devices may include electronic memory, optical memory, and removable storage media. The one or more modules 317 may include a gateway sensor communication module 320, device identifier (e.g. MAC ID) processing module 322, communication to interactive marketing server module 324, sensor server control/OS module 326, sensor analytics module 328, wireless carrier interface module 330, beacon stuffing module 332, dashboard control module 334, and network management/diagnostic/admin module 336. The modules 317 may be implemented by the one or more processors in the processor bank 310.

The sensor provider's server 305 and any other server described in the present disclosure may include a database stored in a storage device bank or may be coupled to a database. Further, such a computer server may be part of a computer server system described herein that may include one or more computer servers and one or more databases. In the present disclosure, a computer server may, but not always, refer to embodiments that include a computer server system having one or more computer servers and one or more databases coupled to each other. The one or more computer servers may be co-located with each other or distributed among different locations. Likewise, the one or more one or more databases may be co-located with each other or distributed among different locations. In further embodiments, some of the one or more computer servers may be co-located and coupled to the one or more databases while in additional embodiments some of the one or more computer servers may be coupled to the one or more databases each of which are placed in different location. In still further embodiments, a computer server system may refer to at least one of a computer server and a database.

The gateway sensor communication module 320 allows the sensor provider's server 305 to communicate with a gateway sensor (through an access point) and thereby communicate with one or more data sensors. In some embodiments the sensor provider's server 305 may communicate directly to the one or more data sensors. The gateway sensor communication module 320 may use wired and/or wireless technologies to communicate with the gateway sensor.

In one embodiment, the gateway sensor communication module 320 may receive (via the gateway sensor and access point) a device identifier of a shopper's mobile device acquired by a data sensor in proximity to an interactive marketing display. Further, the gateway sensor communication module 320 may receive a timestamp of when the device identifier was acquired by the data sensor. In addition, the gateway sensor communication module 320 may receive a sensor ID of the data sensor.

The device identifier processing module 322 may receive the device identifier and timestamp from the gateway sensor communication module 320. Further, the device identifier processing module 322 may also receive the sensor ID of the data sensor that acquired the device identifier. In addition, the device identifier processing module 322 may determine the location of the data sensor that acquired the device identifier based on the sensor ID. The data sensor may provide the device identifier, the timestamp of when the device identifier was acquired, and the location of the data sensor that acquired the device identifier to an interactive marketing display provider's server using a communication to interactive marketing server module 324. Such a communication module 324 may use wired and/or wireless communication technologies to allow information and data to be exchanged between the sensor provider's server 305 and the interactive marketing display provider's server.

The sensor server/OS module 326 may include control software applications that implement software functions that assist in performing certain tasks for the sensor provider's server 305 such as providing access to a communication link (e.g. wired, wireless, Bluetooth, infra-red, RF, etc.), executing an operating system, managing software drivers for peripheral components, and processing information. In addition, the sensor server/OS module 326 may also include software drivers for peripheral components, user interface computer programs, debugging and troubleshooting software tools. Also, the sensor server control/OS module 326 may include an operating system supported by the sensor provider computer server. Such operating systems are known in the art for such servers but may also include computer operating systems (e.g. Windows, Linux, UNIX, previous version of Windows and MacOS, etc.).

The sensor analytics module 328 allows the sensor provider's server 305 to receive analytics information from sensors within a sensor network. Such analytics information may include the length of time a certain mobile device was in proximity of a certain sensor, the different sensors that detect the presence of a certain mobile device, the number of mobile devices detected by certain sensor over a period of time, the number of mobile devices detected at different times of day, and other analytics information known in the art. Such analytical information may be provided to an interactive marketing display provider's server, retailer server, sensor provider personnel device, and any other device allowed by the sensor provider's server 305.

The dashboard control module 334 may allow an interactive marketing display provider's server, retailer server, sensor provider personnel, or any other device to view the sensor analytics information obtained and processed by the sensor provider's server 305. Further, the dashboard control module may allow the interactive marketing display provider's server, retailer server, and sensor provider personnel to configure (in some instances in a limited fashion) or access additional information from different sensors in the sensor network.

The wireless carrier interface module 330 allows the sensor provider's server 305 to exchange information with a wireless carrier to facilitate attribution of the shopper's interaction with interactive marketing displays. In one embodiment, the wireless carrier interface module 330 may provider a wireless carrier server with the location of a data sensor in proximity to an interactive marketing display (based on a sensor ID) and request the wireless carrier for identity of the subscribers near (within a distance threshold) the location of the data sensor. The wireless carrier server may respond to the wireless interface carrier module 330 with the identity (e.g. mobile telephone number) of one or several subscribers' mobile devices within a distance threshold of the data sensor location. The identity of the subscribers' mobile devices may be provided to the interactive marketing display provider's server using the communication to interactive marketing server module 324 so that the interactive marketing display provider's server (and possibly in conjunction with a retailer server) attribute a shopper identity with the shopper interacting with an interactive marketing display or a shopper making a purchase with a purchase incentive provided by the interactive marketing display.

The beacon stuffing module 332 allows the sensor provider's server 305 to provide a coupon or other purchase incentive to access point (which may be a data sensor) that detects a shopper's mobile device and the access point provides the coupon or other purchase incentive to the shopper's mobile device using beacon stuffing techniques described herein.

The network management/diagnostic/admin module 336 is used by sensor provider personnel to configure, manage, and maintain a network of sensors coupled to the sensor provider's server 305.

Each of the communication interfaces (335-350) may be software or hardware associated in communicating to other devices. The communication interfaces (335-350) may be of different types that include a user interface, USB, Ethernet, WiFi, WiMax, wireless, optical, cellular, or any other communication interface coupled to a communication network. One or more of the communication interfaces (335-350) may be coupled to a user interface known in the art , inter alia, for installation and diagnostic purposes.

An intra-device communication link 355 between the processor bank 310, storage device bank 315, modules 317, and communication interfaces (335-350) may be one of several types that include a bus or other communication mechanism.

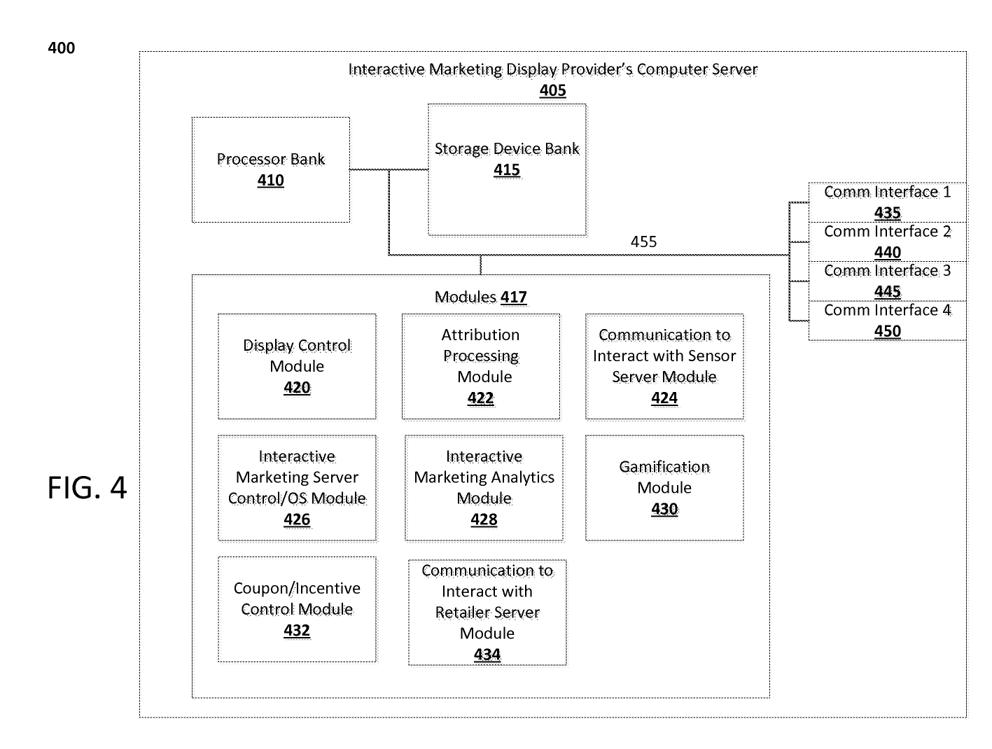

FIG. 4 is a functional block diagram of an interactive marketing display provider's computer server 405 used in a system for interactive marketing with attribution with proximity sensors in accordance with some embodiments. Such an interactive marketing display provider's (computer) server 405 may be used in a system shown in FIGS. 1B-1D and operated by an interactive marketing provider and may control one or more interactive marketing displays . The interactive marketing display provider's server 405 may include several different components such as a processor bank 410, storage device bank 415, one or more software applications, which may be executed by a processor. Thus, the combination of the software applications as well as the processor and any other hardware form specifically- configured module devices 417. The interactive marketing provider server 405 also has one or more communication interfaces (435-450). The processor bank 410 may include one or more processors that may be co-located with each other or may be located in different parts of the interactive marketing display provider's server 405. The storage device bank 415 may include one or more storage devices. Types of storage devices may include electronic memory, optical memory, and removable storage media. The one or more modules 417 may include a display control module 420, attribution processing module 422, communication to interact with sensor server communication module 424, interactive marketing server control/OS module 426, interactive marketing analytics module 428, gamification module 430, coupon/incentive module 432, and communication to interact with retailer server module 434. The modules 417 may be implemented by the one or more processors in the processor bank 410.

The display control module 420 allows the interactive marketing display provider's server 405 to control one or more interactive marketing displays as shown in FIGS. 1B-1D. This may include the interactive marketing display provider's server 405 to display different content on the interactive marketing displays, configure possible shopper selections, the time in which certain content is presented to the shopper. the sequence of content and/or selections are presented to a shopper based on previous content displayed or previous chosen selections. In some embodiments, the display control module 420 may allow the interactive marketing display to provide the shopper with a coupon or incentive (via a printer or captured image by the shopper's mobile device). Further, the display control module 420 may configure an interactive marketing display to query the shopper for shopper identity information.

In addition, the display control module 420 may receive, interaction data, analytics information from the interactive marketing display and/or interactive display controller and shopper identity information. Such information may be provided to other modules of the interactive marketing display provider's server 405.

The attribution processing module 422 may receive interaction data that includes a timestamp of when the interaction data was acquired by an interactive marketing display/interactive marketing display controller via the display control module 420. In one embodiment, the attribution processing module 422 may receive shopper identity information (e.g. name, email address, mobile telephone number, loyalty card information, etc.) from the interactive marketing display (via the display control module 420). In other embodiments, the attribution processing module 422 may receive a shopper's identity information (e.g. device identifier) from a sensor provider's server that is received from the communication to interact with sensor module 424 (through a wired and/or wireless communication technologies). Further, the attribution processing module 422 attributes the interaction data with the shopper's identity information. Upon determining the attribution, the interactive marketing display provider's server 405 may provide the attribution information to a retailer server through the communication to interact with retailer server module 434 (through a wired and/or wireless communication technologies).

The interactive marketing server control/OS module 426 may include control software applications that implement software functions that assist in performing certain tasks for the interactive marketing server 405 such as providing access to a communication link (e.g. wired, wireless, Bluetooth, infra-red, RF, etc.), executing an operating system, managing software drivers for peripheral components, and processing information. In addition, the interactive marketing server control/OS module 426 may also include software drivers for peripheral components, user interface computer programs, debugging and troubleshooting software tools. Also, the interactive marketing server control/OS module 426 may include an operating system supported by the interactive marketing display provider's server. Such operating systems are known in the art for such servers but may also include computer operating systems (e.g. Windows, Linux, UNIX, previous version of Windows and MacOS, etc.).

The interactive marketing analytics module 428 receives the analytics information from the interactive marketing displays and interactive marketing display controller (through the display control module 420) and processes the analytics information to provide to one or more retailer servers. Such analytic information may include the number of shoppers at a particular interactive marketing display, the length of time a shopper remains in front of an interactive marketing display, the number of interactive marketing displays visited by a particular shopper, etc.

The gamification module 430 determines the sequence of content and shopper selections to display on an interactive marketing display. Further, the gamification module 430 determines the level of engagement (e.g. number of levels of interaction, number of selections, etc.) needed to provide a shopper with a coupon or other purchase incentive. Such a level of engagement may also be called an engagement threshold.

The coupon/incentive control module 432 provides the coupon or other purchase incentive (e.g. reservation, layaway, bid, etc.) to the interactive marketing display and/or interactive marketing display controller and to be provided to the shopper. Such a coupon or other purchase incentive may be printed or captured as an image by a shopper's mobile device.

Each of the communication interfaces (435-450) may be software or hardware associated in communicating to other devices. The communication interfaces (435-450) may be of different types that include a user interface, USB, Ethernet, WiFi, WiMax, wireless, optical, cellular, or any other communication interface coupled to a communication network. One or more of the communication interfaces (435-450) may be coupled to a user interface known in the art, inter alia, for installation and diagnostic purposes.

An intra-device communication link 455 between the processor bank 410, storage device bank 415, modules 417, and communication interfaces (435-450) may be one of several types that include a bus or other communication mechanism.

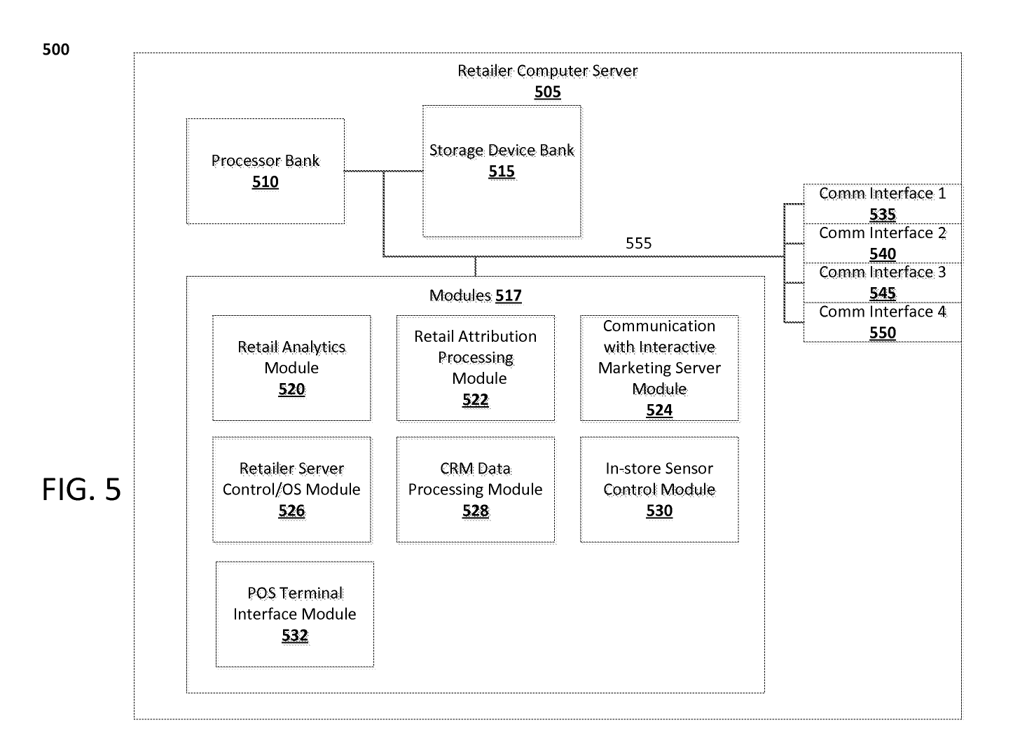

FIG. 5 is a functional block diagram of a retailer computer server 505 used in a system for interactive marketing with attribution with proximity sensors in accordance with some embodiments. Such a retailer (computer) server 505 may be used in a system shown in FIGS. 1B-1D and operated by an interactive marketing provider and may control one or more interactive marketing displays . The retailer server 505 may include several different components such as a processor bank 510, storage device bank 515, one or more software applications, which may be executed by a processor. Thus, the combination of the software applications as well as the processor and any other hardware form specifically-configured module devices 517. The retailer computer server also has one or more communication interfaces (535-550). The processor bank 510 may include one or more processors that may be co-located with each other or may be located in different parts of the retailer server 505. The storage device bank 515 may include one or more storage devices. Types of storage devices may include electronic memory, optical memory, and removable storage media. The one or more modules 517 may include a retail analytics module 520, retail attribution processing module 522, communication with interactive marketing server module 524, retailer server control/OS module 526, CRM data processing module 528, in-store sensor control module 530, and a POS Terminal interface module. The modules 517 may be implemented by the one or more processors in the processor bank 510.

The retail analytics module 520 may receive analytics information from an interactive marketing server through a communication with interactive marketing module 524 as well as from POS terminals. The retail analytics information may include the number of shoppers at a particular interactive marketing display, the length of time a shopper remains in front of an interactive marketing display, the number of interactive marketing displays visited by a particular shopper, etc. Further, the retail analytics information may include the number of a particular item purchased over a period of time, the number of coupons redeemed from an interactive marketing display, the number of items purchased that was displayed on an interactive marketing display, etc.

The retail attribution processing module 522 may attribute a shopper's identity received from a POS terminal or from a CRM server (through the CRM data processing module 528) with interaction data received from the interactive marketing server or a transaction at a POS terminal. For example, a shopper may redeem a coupon provided by an interactive marketing display at a POS terminal and provide shopper identity information as part of the transaction. The retail attribution processing module 522 may then attribute the interaction data that includes providing the coupon with the shopper's identity. In another example, interaction data shows a shopper is interacting with an interactive marketing display at certain time. Further, a sensor provides the identity of one or more subscribers of a wireless carrier are in proximity of the interactive marketing display at the same time period. The retail attribution processing module 522 may determine the shopper's identity using a CRM data, based on the subscriber information (e.g. device identifier of subscriber's mobile device), to attribute the interaction data with a shopper.

The retailer server/OS module 526 may include control software applications that implement software functions that assist in performing certain tasks for the retail server 405 such as providing access to a communication link (e.g. wired, wireless, Bluetooth, infra-red, RF, etc.), executing an operating system, managing software drivers for peripheral components, and processing information. In addition, the retail server/OS module 426 may also include software drivers for peripheral components, user interface computer programs, debugging and troubleshooting software tools. Also, the retail server control/OS module 426 may include an operating system supported by the sensor provider computer server. Such operating systems are known in the art for such servers but may also include computer operating systems (e.g. Windows, Linux, UNIX, previous version of Windows and MacOS, etc.).

The CRM data processing module 528, as mentioned herein, provides subscriber information obtained from a wireless carrier to a CRM server. In response, the CRM server provides shopper identity information based on subscriber information (e.g. device identity of the subscriber's mobile device)that may be used to attribute interaction data with the shopper's identity.

The POS terminal interface module 532 assists the retailer server 505 to communicate with one or more POS terminals controlled or operated by the retailer. This includes receiving POS terminal purchase transaction information that assists in attribution of a shopper's identity with interaction with an interactive marketing display or a shopper's identity with a redeemed coupon.

The in-store sensor control module 530 allows the retail server 505 to provide configuration information to one or more sensors in a sensor network controlled by the retailer within a retailer's store.

Each of the communication interfaces (535-550) may be software or hardware associated in communicating to other devices. The communication interfaces (535-550) may be of different types that include a user interface, USB, Ethernet, WiFi, WiMax, wireless, optical, cellular, or any other communication interface coupled to a communication network. One or more of the communication interfaces (535-550) may be coupled to a user interface known in the art, inter alia, for installation and diagnostic purposes.

An intra-device communication link 555 between the processor bank 510, storage device bank 515, modules 517, and communication interfaces (535-550) may be one of several types that include a bus or other communication mechanism.

### Description of Flowcharts of Methods of the System for Interactive Marketing with Attribution Using Proximity Sensors

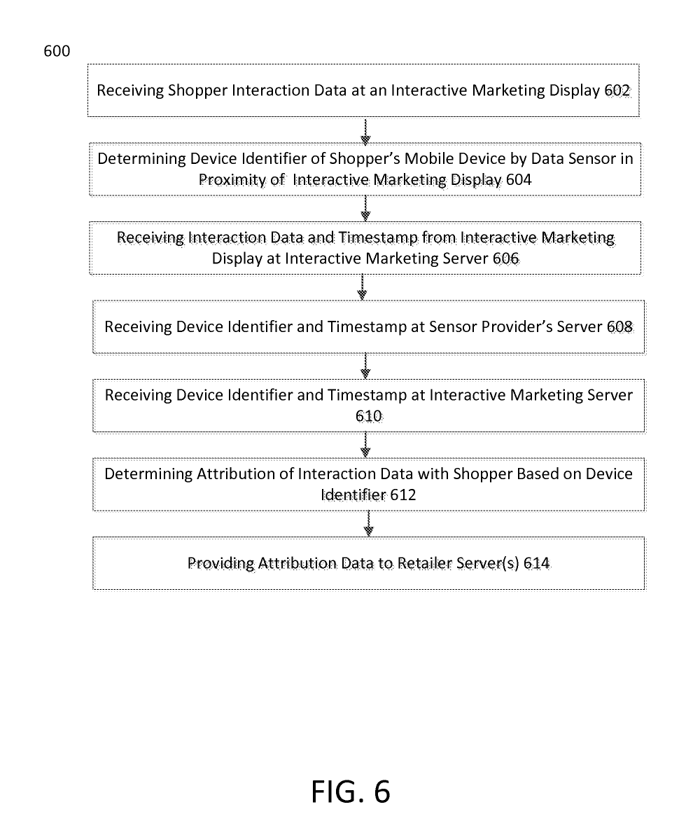

FIGS. 6-9 are example flowcharts of methods for interactive marketing with attribution with proximity sensors in accordance with some embodiments. Referring to FIG. 6, the method 600 includes receiving shopper interaction data at an interactive marketing display 602, as shown in block 602. The method 600 further includes determining a device identifier of a shopper's mobile device by a data sensor in proximity of an interactive marketing display, as shown in block 604. In addition, the method 600 includes receiving interaction data and timestamp of interaction from the interactive marketing display and/or interactive marketing display controller at an interactive marketing display provider's server, as shown in block 606. The method 600 also include receiving a device identifier and timestamp of when the device identifier was acquired at a sensor provider's server from the data sensor, as shown in block 608. Further, the method 600 further includes the interactive marketing display's provider server receiving the device identifier and timestamp (of when the device identifier was acquired) from the sensor provider's server, as shown in block 610. In addition, the method 600 includes the interactive marketing display provider's server determines attribution of interaction data with shopper based on the device identifier, as shown in block 612. The method 600 includes providing attribution data to one or more retailer servers, as shown in block 614.

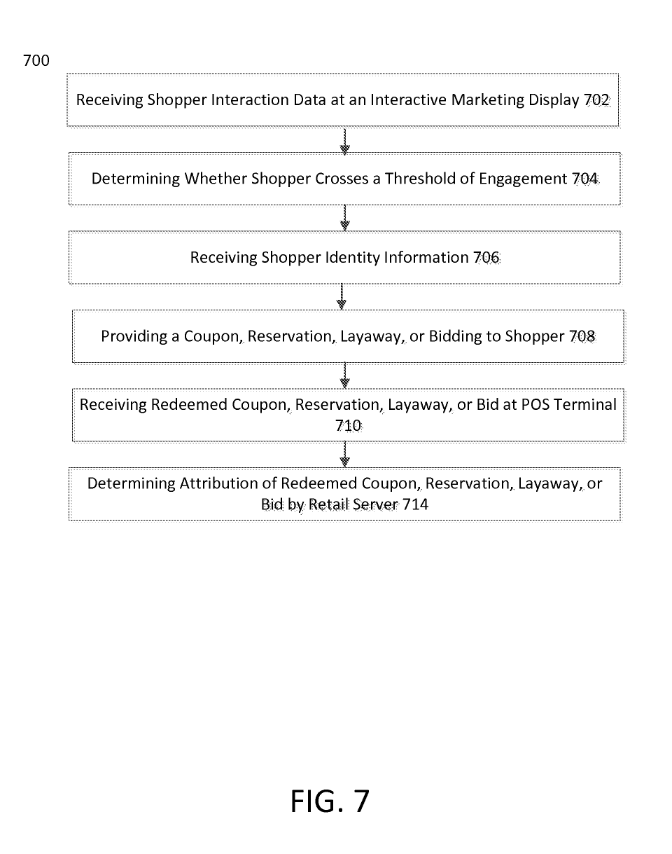

Referring to FIG. 7, a flow chart of a method 700 for attribution of interactive marketing using proximity sensors and gamification is shown. The method 700 includes receiving shopper interaction data at an interactive marketing display, as shown in block 702. The method 700 further includes determining whether a shopper crosses a threshold of engagement (e.g. a predetermined number of levels, selections, etc.) when interacting with an interactive marketing display, as shown in block 704. In addition, the method 700 further includes receiving shopper identity information at the interactive marketing display, as shown in block 706. The method 700 also includes providing a coupon or other purchase incentive (e.g. reservation, layaway, or bid) to shopper by at least one of an interactive marketing display, interactive marketing display controller, and interactive marketing display provider's server, as shown in block 708. The method 700 further includes receiving the redeemed coupon (or purchase incentive) at a POS terminal, as shown in block 710. In addition, the method 700 includes determining attribution of redeemed coupon, reservation, layaway, or bid by the retail server 714.

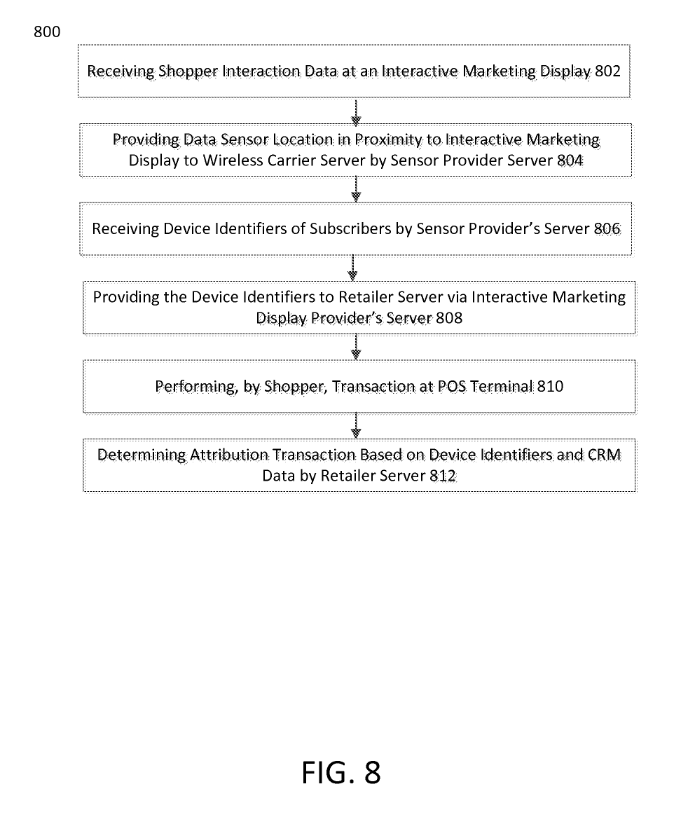

Referring to FIG. 8, a flow chart of a method 800 for attribution of interactive marketing using proximity sensors and wireless carrier generated information is shown. The method 800 includes receiving shopper interaction data at an interactive marketing display that is forwarded and recorded by an interactive marketing display controller, as shown in block 802. The method 800 further includes providing data sensor location in proximity to interactive marketing display to wireless carrier server by sensor provider's server, as shown in block 804. In addition, the method 800 includes receiving the device identifiers of subscribers by the sensor provider's server, as shown in block 806. The method 800 includes providing the device identifiers to the retailer sever via the interactive marketing display provider's server, as shown block 808. The method 800 further includes shopper performing transaction at a POS terminal, as shown in block 810. In addition, the method 800 includes determining attribution of transaction based on device identifiers and CRM data (as described herein) by retailer server, as shown in block 812.

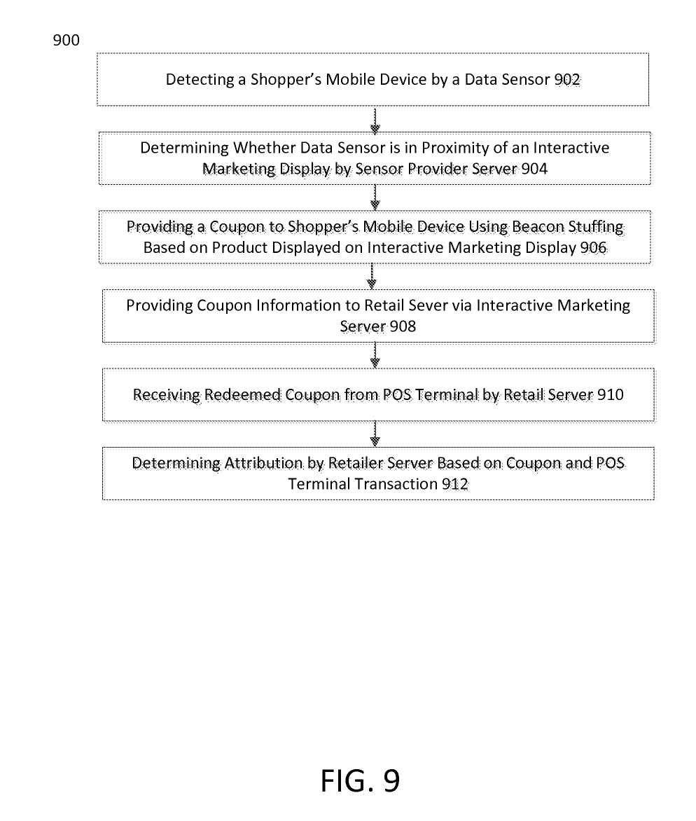

Referring to FIG. 9, a flow chart of a method 900 for attribution of interactive marketing using WiFi Beacon Stuffing. The method 900 includes a data sensor detecting a shopper's mobile device, as shown in block 902. The method 900 further includes determining whether the data sensor is in proximity of an interactive marketing display by sensor provider's server, as shown in block 904. In addition, the method 900 includes providing a coupon or purchase incentive to shopper's mobile device using beacon stuffing based on product displayed on interactive marketing display, as shown in block 908. The method 900 includes receiving the redeemed coupon or purchase incentive from POS terminal by retail server, as shown in block 910. The method 900 further includes determining attribution by the retailer server based on coupon or purchase incentive and POS terminal transaction, as shown in block 912.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Further, persons of ordinary skill in the art would understand that embodiments of the present disclosure may be combined, integrated, or separated.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Further, the embodiments disclosed may be implemented individually or in combination with other embodiments or aspects thereof.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system, comprising:
(a) an interactive marketing display controller;
(b) one or more interactive marketing displays, coupled to the interactive marketing display controller, that provide marketing information to a shopper and allow the shopper to interact with the interactive marketing display, the interactive marketing display controller of each interactive marketing display recording interaction data with the shopper and a timestamp of interaction;
(c) one or more data sensors, each data sensor being in proximity to at least one of the one or more interactive marketing displays, wherein each data sensor senses the shopper's mobile device, acquires a device identifier of the shopper's mobile device, and records a timestamp of when the shopper's mobile device is sensed;
(d) a sensor provider's server coupled to the one or more data sensors that receives the device identifier of the shopper's mobile device and the timestamp of when the shopper's mobile device was sensed;
(e) a retailer server;
(f) an interactive marketing display provider's server coupled to the one or more interactive marketing displays, retailer server, and a sensor provider's server, wherein the interactive marketing display provider's server: (i) receives the interaction data for the shopper and the timestamp of the interaction from the interactive marketing display controller of the one or more interactive marketing displays; (ii) receives, from the sensor provider's server, the device identifier of the shopper's mobile device and the timestamp of when the shopper's mobile device was sensed; (iii) combines the interaction data and the device identifier of the shopper's mobile device; (iv) provides the combined interaction data and device identifier to the retail server for attribution.

2. The system of claim 1, further comprising:
(a) an access point coupled to the sensor provider's server;
(b) one or more gateway sensors coupled to the access point;
(c) the one or more data sensors coupled to the one or more gateway sensors wherein the one or more data sensors communicate with the sensor provider's server through the one or more gateway sensors.

3. The system of claim 1, wherein the interactive marketing display provider's server communicates with the one or more interactive marketing displays through the interactive marketing display controller.

4. The system of claim 1, wherein the one or more data sensors senses the shopper's mobile device using at least one of WiFi, Bluetooth, and Bluetooth Low Energy wireless technology.

5. The system of claim 1, wherein the one or more data sensors acquires the device identifier of the shopper's mobile device by communicating with at least one of a mobile application, a modified application and a common mobile application on the shopper's mobile device.

6. The system of claim 1, wherein the one or more data sensors acquires the device identifier of the shopper's mobile device by communicating with shopper's mobile device.

7. An interactive marketing display provider's server device, comprising:
one or more modules configured to: (a) receive an interaction data for a shopper and a timestamp of shopper interaction from an interactive marketing display controller of one or more interactive marketing displays; (ii) receive, from a sensor provider's server, a device identifier of a shopper's mobile device and a timestamp of when the shopper's mobile device was sensed by a data sensor in proximity to the one or more interactive marketing displays; (iii) combine the interaction data and the device identifier of the shopper's mobile device; (iv) provide the combined interaction data and device identifier to a retail server for attribution.

8. The device of claim 7, wherein the interactive marketing display's provider server device communicates with one or more interactive marketing displays through one or more interactive marketing display controller.

9. The device of claim 7, wherein the data sensor senses the shopper's mobile device using at least one of WiFi, Bluetooth, and Bluetooth Low Energy wireless technology.

10. The device of claim 7, wherein the data sensor acquires the device identifier of the shopper's mobile device by communicating with a mobile application on the shopper's mobile device.

11. The device of claim 7, wherein the data sensor acquires the device identifier of the shopper's mobile device by communicating with shopper's mobile device.

12. A method, comprising:
(a) providing, by one or more interactive marketing displays, marketing information to a shopper;
(b) allowing the shopper to interact with the one or more interactive marketing displays;
(c) recording, by an interactive marketing display controller of each interactive marketing display, interaction data with the shopper and a timestamp of interaction;
(d) sensing the shopper's mobile device, by one or more data sensors in proximity to at least one of the one or more interactive marketing displays;
(e) acquiring a device identifier of the shopper's mobile device, by the one or more data sensors;
(f) recording a timestamp of when the shopper's mobile device is sensed;
(g) receiving, by an interactive marketing display provider's server, the interaction data for the shopper and the timestamp of the interaction from the interactive marketing display controller;
(h) receiving, by an interactive marketing display provider's server, the device identifier of the shopper's mobile device and the timestamp of when the shopper's mobile device was sensed from the sensor provider's server;
(i) combining the interaction data and the device identifier of the shopper's mobile device;
(j) providing the combined interaction data and device identifier to the retail server for attribution.

13. The method of claim 12, wherein:
(a) an access point is coupled to the sensor provider's server;
(b) one or more gateway sensors is coupled to the access point;
(c) the one or more data sensors are coupled to the one or more gateway sensors wherein the one or more data sensors communicate with the sensor provider's server through the one or more gateway sensors.

14. The method of claim 12, wherein the interactive marketing display provider's server communicates with the one or more interactive marketing displays through the interactive marketing display controller.

15. The method of claim 12, wherein the one or more data sensors senses the shopper's mobile device using at least one of WiFi, Bluetooth, and Bluetooth Low Energy wireless technology.

16. The method of claim 12, wherein the one or more data sensors acquires the device identifier of the shopper's mobile device by communicating with a mobile application on the shopper's mobile device.

17. The method of claim 12, wherein the one or more data sensors acquires the device identifier of the shopper's mobile device by communicating with shopper's mobile device.

18. A system, comprising:
(a) an interactive marketing display provider's server;
(b) one or more interactive marketing displays;
(c) one or more interactive marketing display controllers coupled to the interactive marketing display provider's server and the one or more interactive marketing displays, wherein the one or more interactive marketing display controllers: (i) receives shopper interaction data; (ii) determines whether the shopper exceeds an engagement threshold; (iii) receives shopper identity information from the shopper; (iv) provides a purchase incentive to the shopper;
(d) a POS terminal, located on premises of a retailer, that receives and processes the redeemed purchase incentive;
(e) a retailer server coupled to the POS terminal, the retailer server determining an attribution of the redeemed purchase incentive to the shopper identity.

19. The system of claim 18, wherein the interactive marketing display provider's server communicates with the one or more interactive marketing displays through the one or more interactive marketing display controllers.

20. The system of claim 18, further comprising a printer coupled to the one or more interactive marketing displays controllers wherein the one or more interactive marketing display controllers provide a purchase incentive to the shopper by printing the purchase incentive using the printer based on the shopper exceeding the engagement threshold such that the printed purchase incentive can be redeemed at the POS terminal of a retailer.

21. The system of claim 18, wherein the one or more interactive marketing displays presents an image that is capable of being captured by the shopper's mobile device, the image including the purchase incentive for the shopper based on the shopper exceeding the engagement threshold such that the image that includes purchase incentive can be redeemed at the POS terminal of a retailer.

22. A retailer server device, comprising:
one or more modules configured to:
(i) receive a redeemed purchase incentive from a POS terminal wherein the purchase incentive was provided to a shopper by an interactive marketing display controller after the shopper exceeded an engagement threshold and the shopper redeemed the purchase incentive at the POS terminal;
(ii) determine the attribution of the redeemed purchase incentive to shopper identity information received from the interactive marketing display controller.

23. The device of claim 22, wherein purchase incentive is provided to the shopper by a printer coupled to an interactive marketing display controller based on the shopper exceeding the engagement threshold.

24. The device of claim 22, wherein purchase incentive is in the form of an image is presented to the shopper by an interactive marketing display controller based on the shopper exceeding the engagement threshold such that the presented image can be captured by the shopper's mobile device.

25. A method, comprising:
(a) receiving, by an interactive marketing display controller, shopper interaction data from an interactive marketing display;
(b) determining, by the interactive marketing controller, whether the shopper exceeds an engagement threshold;
(c) receiving, at the interactive marketing display, shopper identity information and transmitting the shopper identity information to the interactive marketing display controller;
(d) providing, by the interactive marketing controller to the interactive marketing display, a purchase incentive to the shopper;
(e) receiving and processing, by a POS terminal located at the retailer's premises, a redeemed purchase incentive;
(f) determining, by retail server, attribution of the redeemed purchase incentive to the shopper identity information.

26. The method of claim 25, wherein the interactive marketing display provider's server communicates with the interactive marketing display through the interactive marketing display controller.

27. The method of claim 25, wherein purchase incentive is provided to the shopper by a printer coupled to an interactive marketing display controller based on the shopper exceeding the engagement threshold.

28. The method of claim 25, wherein purchase incentive is in the form of an image is presented to the shopper by the interactive marketing display controller based on the shopper exceeding the engagement threshold such that the presented image can be captured by a shopper's mobile device.
